(19) United States
(12) Patent Application Publication
(10) Pub. No.: US 2023/0386078 A1
(43) Pub. Date: Nov. 30, 2023

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventors: Yujiro SOEDA, Kanagawa (JP); Shunta TATE, Tokyo (JP)

(21) Appl. No.: 18/320,298

(22) Filed: May 19, 2023

(30) Foreign Application Priority Data
May 26, 2022 (JP) 2022-086229

(51) Int. Cl. G06T 7/73; G06V 40/16; G06V 10/82; G06V 10/774; G06V 10/24; G06V 10/776

(52) U.S. Cl. CPC G06T 7/74; G06V 40/165; G06V 10/82; G06V 10/774; G06T 2207/20084; G06V 10/776; G06T 2207/30201; G06T 2207/20081; G06V 10/245

(57) ABSTRACT

There is provided with an information processing apparatus. An outputting unit, for each of a plurality of reference angles, outputs an evaluation value indicating whether a detection target in an image is inclined at the reference angle with respect to a standard orientation of the detection target. A first estimating unit estimates an inclination angle of the detection target in the image with respect to the standard orientation based on the evaluation values that have been respectively output for the plurality of reference angles. A detecting unit detects the detection target through processing in which an adjustment has been made using the estimated inclination angle.

### BACKGROUND OF THE INVENTION

### Field of the Invention

The present invention relates to an information processing apparatus, an information processing method, and a storage medium.

### Description of the Related Art

Object detection processing for detecting an object from an image has been applied to functions of image capturing apparatuses, such as digital cameras. Conventionally, the target of the object detection processing has been often limited to human faces; however, in recent years, the development of deep learning has also enabled detection of facial organs, such as pupils, of humans, and such detection has been implemented as a pupil detection function on products.

It has been known that, in training related to facial organ detection that uses deep learning, the accuracy of facial organ detection is increased when the training is performed only with respect to images in which a person therein is substantially upright. However, a facial organ detector that has been realized by such training is highly accurate in detection of facial organs of a face that is substantially upright, but is reduced in accuracy when the inclination of a face is large. In terms of detection of an inclined face, for example, Japanese Patent Laid-Open No. 2017-16512 discloses a technique to determine whether a face is facing forward or facing sideways with use of a plurality of face direction estimators. Furthermore, Japanese Patent Laid-Open No. 2019-32773 discloses a technique to estimate the face direction of a detected face by integrating scores from a plurality of face direction estimators that are realized by machine learning.

### SUMMARY OF THE INVENTION

According to one embodiment of the present invention, an information processing apparatus comprises: an outputting unit configure to, for each of a plurality of reference angles, output an evaluation value indicating whether a detection target in an image is inclined at the reference angle with respect to a standard orientation of the detection target; a first estimating unit configured to estimate an inclination angle of the detection target in the image with respect to the standard orientation based on the evaluation values that have been respectively output for the plurality of reference angles; and a detecting unit configured to detect the detection target through processing in which an adjustment has been made using the estimated inclination angle.

According to another embodiment of the present invention, an information processing apparatus, comprises: an outputting unit configure to, for each of a plurality of reference angles, output an evaluation value indicating whether a detection target in an image is inclined at the reference angle with respect to a standard orientation of the detection target; a first estimating unit configured to estimate an inclination angle of the detection target in the image with respect to the standard orientation based on the evaluation values that have been respectively output for the plurality of reference angles; an obtaining unit configured to obtain data indicating a ground truth of the inclination angle with respect to the standard orientation; and a generating unit configured to, with respect to each of the plurality of reference angles, generate a piece of supervisory data used in training of the evaluation value based on the data indicating the ground truth, wherein the outputting unit has been trained so as to reduce an error between the evaluation values and the pieces of supervisory data.

According to still another embodiment of the present invention, an information processing method comprises: outputting, for each of a plurality of reference angles, an evaluation value indicating whether a detection target in an image is inclined at the reference angle with respect to a standard orientation of the detection target; estimating an inclination angle of the detection target in the image with respect to the standard orientation based on the evaluation values that have been respectively output for the plurality of reference angles; and detecting the detection target through processing in which an adjustment has been made using the estimated inclination angle.

According to yet another embodiment of the present invention, an information processing method, comprises: outputting, for each of a plurality of reference angles, an evaluation value indicating whether a detection target in an image is inclined at the reference angle with respect to a standard orientation of the detection target; estimating an inclination angle of the detection target in the image with respect to the standard orientation based on the evaluation values that have been respectively output for the plurality of reference angles; obtaining data indicating a ground truth of the inclination angle with respect to the standard orientation; and generating, with respect to each of the plurality of reference angles, a piece of supervisory data used in training of the evaluation value based on the data indicating the ground truth, the outputting has been trained so as to reduce an error between the evaluation values and the pieces of supervisory data.

According to still yet another embodiment of the present invention, a non-transitory computer-readable storage medium stores a program which, when executed by a computer comprising a processor and a memory, causes the computer to: outputting, for each of a plurality of reference angles, an evaluation value indicating whether a detection target in an image is inclined at the reference angle with respect to a standard orientation of the detection target; estimating an inclination angle of the detection target in the image with respect to the standard orientation based on the evaluation values that have been respectively output for the plurality of reference angles; and detecting the detection target through processing in which an adjustment has been made using the estimated inclination angle.

According to yet still another embodiment of the present invention, a non-transitory computer-readable storage medium stores a program which, when executed by a computer comprising a processor and a memory, causes the computer to: outputting, for each of a plurality of reference angles, an evaluation value indicating whether a detection target in an image is inclined at the reference angle with respect to a standard orientation of the detection target; estimating an inclination angle of the detection target in the image with respect to the standard orientation based on the evaluation values that have been respectively output for the plurality of reference angles; obtaining data indicating a ground truth of the inclination angle with respect to the standard orientation; and generating, with respect to each of the plurality of reference angles, a piece of supervisory data used in training of the evaluation value based on the data indicating the ground truth, the outputting has been trained so as to reduce an error between the evaluation values and the pieces of supervisory data.

Further features of the present invention will become apparent from the following description of exemplary embodiments (with reference to the attached drawings).

### BRIEF DESCRIPTION OF THE DRAWINGS

FIG. 1A and FIG. 1B are diagrams for describing examples of an inclination of a face that serves as a detection target according to a first embodiment.

FIG. 2 is a block diagram showing an example of a system including an information processing apparatus according to the first embodiment.

FIG. 3 is a block diagram showing an example of a hardware configuration of the information processing apparatus according to the first embodiment.

FIG. 4 is a block diagram showing an example of a functional configuration of the information processing apparatus according to the first embodiment.

FIG. 5 is a diagram for describing input/output data associated with a detector according to the first embodiment.

FIG. 6 is a diagram for describing maps output from the detector according to the first embodiment.

FIG. 7 is a diagram for describing an inclination angle estimated by the information processing apparatus according to the first embodiment.

FIG. 8 is a flowchart showing an example of adjusted detection processing according to the first embodiment.

FIG. 9 is a block diagram showing an example of a functional configuration of a training apparatus according to the first embodiment.

FIG. 10A, FIG. 10B, and FIG. 10C are diagrams showing examples of ground truth information and a map of training according to the first embodiment.

FIG. 11 is a diagram for describing processing for generating maps from the ground truth information according to the first embodiment.

FIG. 12 is a flowchart showing an example of training processing according to the first embodiment.

FIG. 13 is a diagram for describing maps output from the detector according to the first embodiment.

FIG. 14 is a block diagram showing an example of a functional configuration of an information processing apparatus according to a second embodiment.

FIG. 15 is a diagram for describing maps output from a detector according to the second embodiment.

FIG. 16 is a block diagram showing an example of a functional configuration of a training apparatus according to the second embodiment.

FIG. 17A and FIG. 17B are diagrams showing examples of ground truth information and a map of training according to the second embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

The technique described in Japanese Patent Laid-Open No. 2017-16512 merely determines whether a face is facing forward or facing sideways, and cannot make a detailed determination about in which direction the face is facing. Furthermore, the technique described in Japanese Patent Laid-Open No. 2019-32773 merely calculates the face direction of a detected face, and cannot perform a detection while making a correction in accordance with the inclination of the face.

Embodiments of the present invention provide an information processing apparatus that detects an inclined detection target in an image with high accuracy.

### First Embodiment

An information processing apparatus according to an embodiment of the present invention detects a detection target in an image. Especially, for each of a plurality of reference angles, the information processing apparatus outputs an evaluation value indicating whether the detection target in the image is inclined at the reference angle with respect to a standard orientation. Next, the information processing apparatus estimates an inclination angle of the detection target in the image with respect to the standard orientation based on the evaluation values, and detects the detection target through processing in which an adjustment is made using the estimated inclination angle.

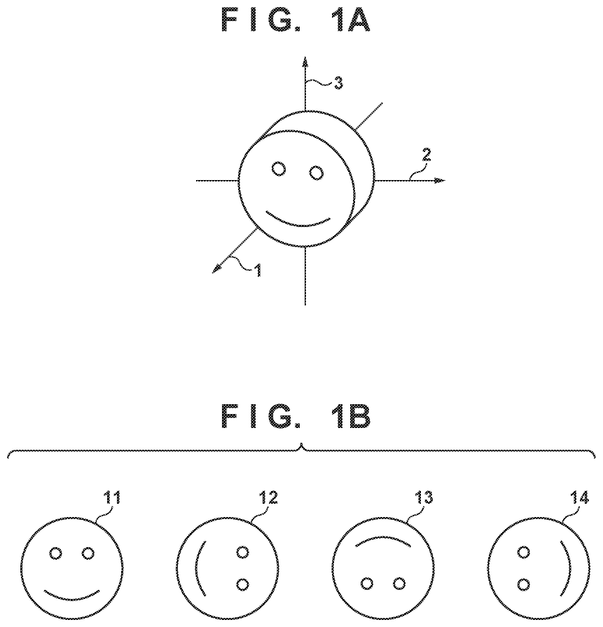

The information processing apparatus according to the present embodiment detects a detection target from images captured by a camera, which is an image capturing apparatus. FIGS. 1A and 1B are diagrams showing examples in which a face, which is a detection target according to the present embodiment, is inclined with respect to a standard orientation. In the present embodiment, a vertically-oriented face with the top of the head located on the upper side, which is shown in FIG. 1A, is detected as a standard orientation of a face. FIG. 1B shows a face 11 in the standard orientation, a face 12 that is inclined rightward, a face 13 with the top of the head located on the lower side, and a face 14 that is inclined leftward. In this example, relative to the face 11 in the standard orientation, the face 12 is a face that exhibits a clockwise in-plane rotation of 90°, the face 13 is a face that exhibits a clockwise in-plane rotation of 180°, and the face 14 is a face that exhibits a clockwise in-plane rotation of 270° (a counter-clockwise in-plane rotation of 90°).

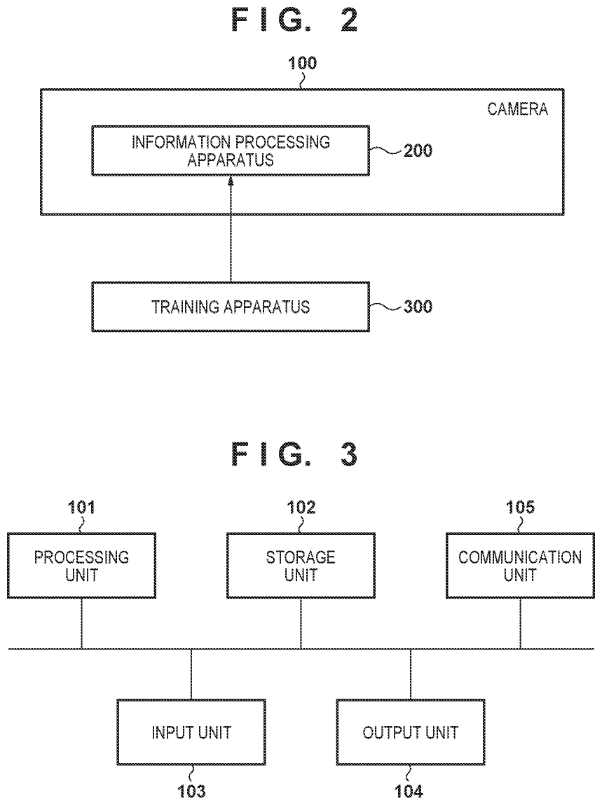

FIG. 2 is a diagram showing an example of a configuration of a system that includes an information processing apparatus 200 according to the present embodiment. It is assumed that the information processing apparatus 200 according to the present embodiment is built in a camera 100, executes various types of processing with respect to images captured by the camera 100, and detects a detection target. Note that the information processing apparatus 200 may use images obtained from an apparatus different from the camera 100 as a processing target instead of images captured by the camera 100; the information processing apparatus 200 may include an image capturing function and capture images that are used as a processing target. Here, images may be still images, or also may be images included in a video.

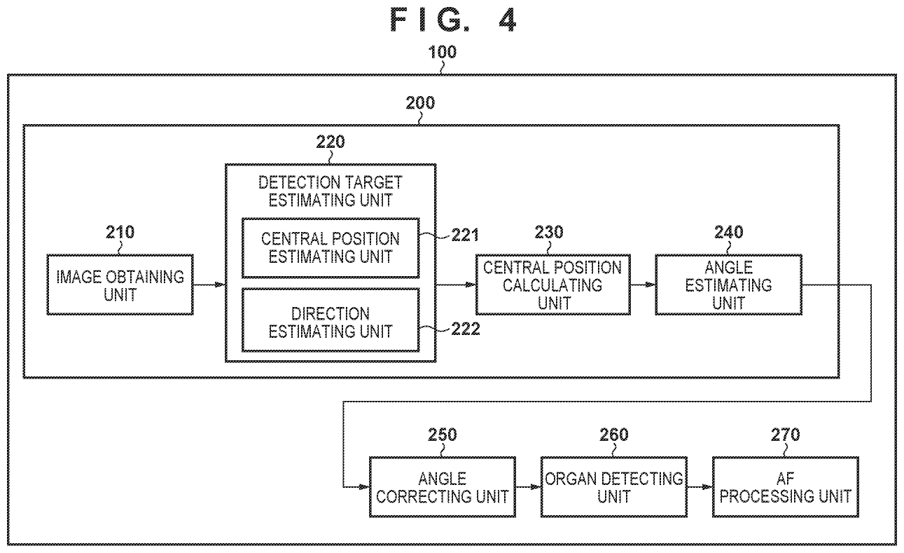

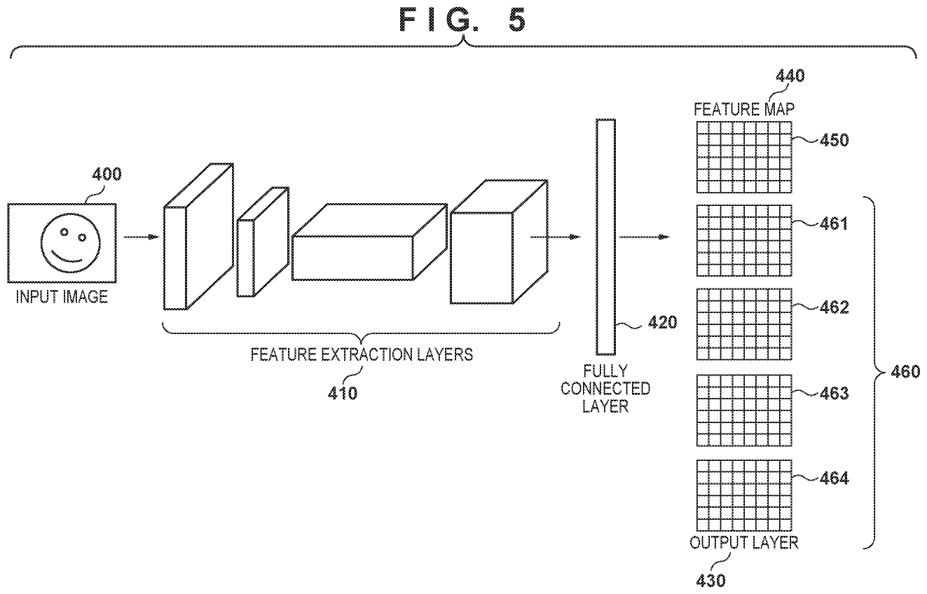

FIG. 3 is a diagram showing an example of a hardware configuration of the information processing apparatus 200 according to the present embodiment. The information processing apparatus 200 includes a processing unit 101, a storage unit 102, an input unit 103, an output unit 104, and a communication unit 105.

The processing unit 101 carries out, for example, the execution of a program stored in the storage unit 102, and controls the operations of the information processing apparatus 200. The processing unit 101 is, for example, a central processing unit (CPU) or a graphics processing unit (GPU). The storage unit 102 is a storage, such as a magnetic storage apparatus and a semiconductor memory, and stores a program that is read in based on the operations of the processing unit 101, data to be stored for a long period of time, or the like. In the present embodiment, processing that is described below, including various types of processing executed by the information processing apparatus 200, is executed as a result of the processing unit 101 reading out the program stored in the storage unit 102 and executing processing. Furthermore, the storage unit 102 may store images captured by the camera 100 according to the present embodiment, the results of processing for such captured images, and so forth.

The input unit 103 is a mouse, a keyboard, a touch panel, a button, or the like, and obtains various types of inputs from a user. The output unit 104 is a liquid crystal panel, an external monitor, or the like, and outputs various types of information. The present embodiment is described under the assumption that the output unit 104 is a liquid crystal panel, and a touch panel that acts as the input unit 103 is mounted on the output unit 104. By using these input unit 103 and output unit 104, the user can perform an input operation via the touch panel while checking the images displayed on the liquid crystal panel.

The communication unit 105 communicates with another apparatus via wired or wireless communication. Furthermore, the function units shown in FIG. 3 are connected in a communication-enabled manner via a system bus, and can transmit and receive various types of information in accordance with processing.

An image capturing unit (not shown) of the camera 100 according to the present embodiment is composed of a lens, a diaphragm, an image sensor, an A/D converter that converts analog signals to digital signals, a diaphragm control unit, and a focus control unit. The image sensor is composed of a CCD, a CMOS, or the like, and converts an optical image of a subject into electrical signals.

Note that the configuration of the overall system is not limited to the above-described example. For example, various types of processing executed by the information processing apparatus 200 may be executed by the camera 100. Also, for example, a training apparatus 300 may be the same apparatus as the camera 100 or the information processing apparatus 200. Furthermore, the camera 100 may include an I/O apparatus for mutually communicating with various types of apparatuses. Here, the I/O apparatus is, for example, an input/output unit such as a memory card and a USB cable, or a transmission/reception unit that uses wired lines, operates wirelessly, or the like.

FIG. 4 is a block diagram showing examples of functional configurations of the information processing apparatus 200, and the camera 100 that includes the information processing apparatus 200. The information processing apparatus 200 according to the present embodiment includes an image obtaining unit 210, a detection target estimating unit 220, a central position calculating unit 230, and an angle estimating unit 240. Furthermore, the detection target estimating unit 220 includes a central position estimating unit 221 and a direction estimating unit 222. The camera 100 includes an angle correcting unit 250, an organ detecting unit 260, and an AF processing unit 270.

The image obtaining unit 210 obtains images included in chronological moving images captured by the image capturing unit of the camera 100. Hereinafter, it is assumed that image data with 1600×1200 pixels is treated as an “image”; however, no particular limitation is intended regarding the size, the format, and the like of the image, as long as various types of processing that are described below can be executed. In the present embodiment, the image obtaining unit 210 obtains images in real time (60 frames per second).

For each of the plurality of reference angles, the detection target estimating unit 220 outputs an evaluation value indicating whether a detection target in an image is inclined at the reference angle with respect to the standard orientation. Here, 90° (rightward), 180° (downward), 270° (or −90°) (leftward) shown in FIG. 1B are used as the reference angles. Therefore, the central position estimating unit 221 outputs a center feature map as a map indicating the likelihood of each position in the image being the central position of the detection target. Furthermore, the direction estimating unit 222 outputs direction feature maps as maps indicating evaluation values indicating whether the detection target is inclined at the reference angles with respect to each position in the image. Each map will be described later. Note that the following description will be provided under the assumption that the detection target is a face of a human body.

The detection target estimating unit 220 according to the present embodiment extracts features from the image using a neural network (NN). FIG. 5 is a schematic diagram of outputs that are produced by the NN of the detection target estimating unit 220 with respect to an input image. In the present embodiment, the NN has a hierarchical structure in which a plurality of modules composed of such layers as convolutional layers, activation layers, pooling layers, and normalization layers, are connected. Here, these modules are collectively referred to as feature extraction layers 410. A fully connected layer 420 receives, as an input, an intermediate feature amount output from the feature extraction layers 410, and outputs feature maps 440 (an output layer 430). Note that as processing in the NN is basically similar to processing implemented using common techniques, a detailed description thereof is omitted.

The feature maps 440 include a face center feature map 450, which is a center feature map, as well as face direction feature maps 460, which are direction feature maps. The face direction feature maps 460 include an upward direction feature map 461, a rightward direction feature map 462, a downward direction feature map 463, and a leftward direction feature map 464 as the direction feature maps that respectively correspond to the reference angles.

The feature maps 440 are pieces of two-dimensional matrix data corresponding to an input image 400. The face center feature map 450 indicates the likelihood of each position being the central position of a human face in the input image 400. Furthermore, with respect to each position, the face direction feature maps 460 indicate the likelihood of the face being tilted at the reference angles. The size of these pieces of matrix data may be the same size as the number of pixels in the input image 400, or may be enlarged or reduced. Hereinafter, it is assumed that, when the term “central position” is simply used, it refers to the central position of the human face.

In the present embodiment, it is assumed that the feature maps 440 are 320×240 maps that have been reduced to ⅕ of the input image in each of the horizontal and vertical directions, and it is assumed that data of each position therein is indicated in the range of 0 to 1. That is to say, in the face center feature map 450, a position that has a higher probability of being the central position of a face has a larger value, and indicates a value close to 1. Also, in the face direction feature maps 460, a position that has a higher probability of being a face tilted at the reference angle has a larger value, and indicates a value close to 1. Furthermore, although the present embodiment is described under the assumption that the face center feature map 450 and the face direction feature maps 460 have the same size, processing that is described below may be executed with respect to a corresponding position under the assumption that these maps have different sizes.

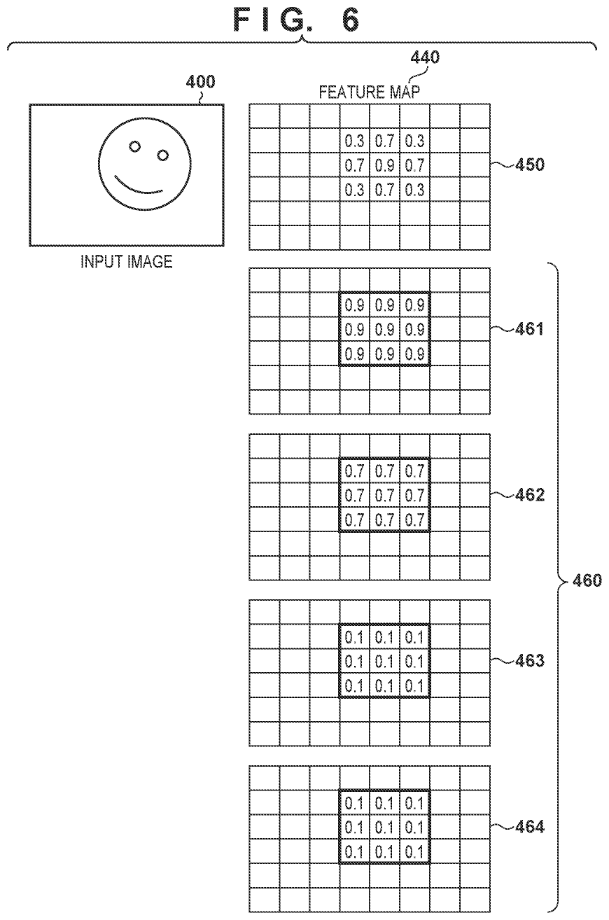

FIG. 6 is a diagram for describing the values of respective elements of the feature maps 440. In the example of FIG. 6, the top of the head of a person is pointed diagonally rightward in the input image 400; thus, in the upward direction feature map 461 and the rightward direction feature map 462, the elements corresponding to a region including a face show values close to 1. In each of the feature maps 440 of FIG. 6, the elements (of the background) that do not correspond to the region including the face have values close to 0; in the present example, these numerical values are depicted as blanks.

The central position calculating unit 230 calculates an image coordinate value of the central position of the face in the image from the face center feature map 450 output from the detection target estimating unit 220. The central position calculating unit 230 can use the position that has a peak value among the elements of the face center feature map 450 (in the example of FIG. 6, the position indicating the value “0.9”) as the element of the central position, and use the corresponding coordinates in the input image 400 as the central position of the face. For example, provided that the element of the central position of the face in the face center feature map 450 is (180, 100), the coordinates of the central position in the input image 400 is (900, 500). Note that this processing is an example, and any other known techniques, such as subpixel estimation and the like, may be used, as long as the central position of the detection target can be estimated.

Note that the central position calculating unit 230 may use an element that exceeds a predetermined threshold as the central position, or use an element that exceeds a predetermined threshold and exhibits a peak as the central position. It is assumed that in a case where there are a plurality of elements that exceed a predetermined threshold or elements that exhibit a peak, a plurality of faces are detected; however, the following description will be provided under the assumption that one face is used as a processing target. In a case where a plurality of faces have been detected, each of these faces may be processed in a similar manner.

The angle estimating unit 240 estimates an inclination angle (a face direction angle) of the face in the image with respect to the standard orientation based on the face direction feature map 460 and on the central position calculated by the central position calculating unit 230. In the present embodiment, the evaluation values for the respective reference angles have been output in connection with the face direction feature maps 460, and the face direction angle estimated based on these evaluation values can be calculated. Hereinafter, it is assumed that the evaluation values for the reference angles are simply referred to as evaluation values.

Next, the aforementioned evaluation values will be described. The central position calculating unit 230 according to the present embodiment calculates the evaluation values from the elements of the face direction feature maps 460 corresponding to the central position. Here, the central position calculating unit 230 can estimate an average of the element corresponding to the central position and eight elements neighboring this element as an evaluation value. The evaluation values that are calculated from the face direction feature maps 461 to 464 of FIG. 6 for up, right, down, and left, respectively, are as follows: (up, right, down, left)=(0.9, 0.7, 0.1, 0.1). The method of calculating the evaluation values is not particularly limited to this; for example, an average of the elements within a predetermined range from the central position, such as four pixels in the vicinity of the element corresponding to the central position or twelve pixels in the vicinity of the same, or only the element corresponding to the central position, may be used as an evaluation value.

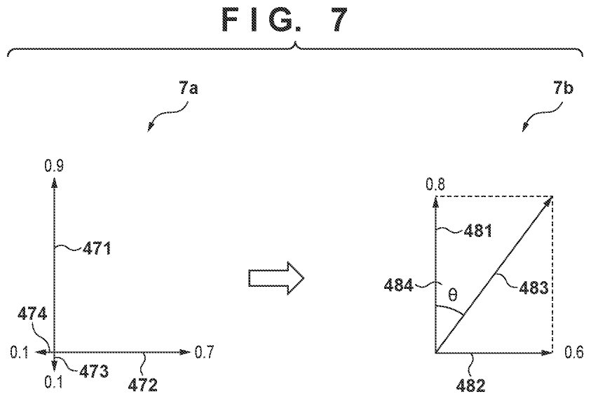

As stated earlier, the angle estimating unit 240 estimates a face direction angle based on the evaluation values. The angle estimating unit 240 may calculate a vector indicating an estimated face direction angle by, for example, combining vectors while using the evaluation values for up, down, left, and right as coefficients of unit vectors for up, down, left, and right, respectively. The calculation of a combined vector that uses the feature maps shown in FIG. 6 will be described with reference to FIG. 7. 7a is a diagram showing vectors in four directions, namely up, down, left, and right, based on the evaluation values calculated from the face direction feature maps 460. An upward direction vector 471, a rightward direction vector 472, a downward direction vector 473, and a leftward direction vector 474 have the lengths of 0.9, 0.7, 0.1, and 0.1, respectively. 7b shows a combined vector obtained by combining these vectors in this case. The length of a combined upward direction vector 481 is set as 0.8 from the difference between the upward direction vector 471 and the downward direction vector 473, and the length of a combined rightward direction vector 482 is set as 0.6 from the difference between the rightward vector 472 and the leftward vector 474. Therefore, a combined vector 483 based on these vectors represents the face direction, and the face direction angle is calculated as an angle 484 (in the example of FIG. 7, approximately 32°).

As described above, in the present embodiment, the values calculated from the likelihoods indicated by the face direction feature maps are used as the evaluation values for the directions of the respective reference angles, and the face direction angle is estimated by combining vectors using these evaluation values. However, the method of estimating the face direction angle is not particularly limited to this, as long as the estimation can be performed based on the face direction feature maps. For example, the angle estimating unit 240 may use, as the face direction angle, a value obtained from a weighted sum of the angles of the directions of the four-directional face direction feature maps (0°, 90°, 180°, and) 270° while using the elements of their respective central positions as weights (a remainder after dividing the value by 360°). Furthermore, the angle estimating unit 240 may use one of the directions corresponding to the largest evaluation value as the face direction angle.

Furthermore, although the present embodiment has been described under the assumption that there are four direction feature maps (for four directions), various types of processing may be executed using a different number of direction feature maps, such as two direction feature maps.

The organ detecting unit 260 detects a face by way of processing in which an adjustment is made using the inclination angle of the detection target (face) in the image with respect to the standard orientation, which has been estimated by the angle estimating unit 240. For example, the organ detecting unit 260 may detect the rotated detection target so as to undo an inclination angle corresponding to the estimated face direction angle. Here, in order to detect the rotated detection target so as to undo an inclination angle corresponding to the face direction angle, the organ detecting unit 260 detects the face from the image after correcting a detection angle of a detector by the face direction angle. The organ detecting unit 260 is composed of a neural network, and has already been trained using an image including the detection target at a substantially upright angle (the standard orientation). Therefore, by correcting the angle of the detector by rotation based on the face direction angle, the detection target can be detected at an accuracy of detection of the detection target in the standard orientation, even in a case where the detection target is not in the standard orientation. Furthermore, for example, the organ detecting unit 260 may first rotate the image by the face direction angle, and then detect the face from the rotated image.

The organ detecting unit 260 according to the present embodiment detects a face as a detection target using a detector for which a detection angle has been corrected by the face direction angle. Here, the detection method thereof is not limited in particular, as long as a human face can be detected. For example, the organ detecting unit 260 may detect a face by detecting human pupils, or may detect a face by detecting other detection parts of a face, such as a nose, a mouth, and ears. In a case where a detection target is a vehicle, such as an automobile, the organ detecting unit 260 may detect the detection target by, for example, detecting a part of the vehicle, such as headlights.

The AF processing unit 270 executes autofocus (AF) processing so as to focus on the human pupils detected by the organ detecting unit 260. As the AF processing can be executed using known techniques, a detailed description thereof is omitted.

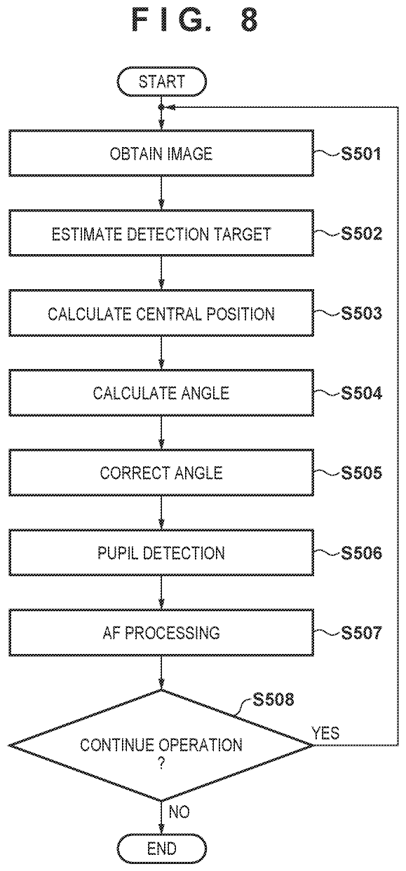

FIG. 8 is a flowchart showing an example of processing for estimating a face direction angle of a detection target in a captured image and detecting the detection target using the estimated face direction angle, which is executed by the information processing apparatus 200 according to the present embodiment. Note that this flowchart is an example, and the information processing apparatus 200 need not execute the entirety of the processing that is described below.

In step S501, the image obtaining unit 210 obtains an image captured by the camera 100. In the present embodiment, it is assumed that the image captured by the camera 100 is bitmap data represented by 8 bits in RGB. In step S502, the detection target estimating unit 220 outputs a face center feature map (a center feature map) and face direction feature maps (direction feature maps) from the captured image obtained in step S501.

In step S503, the central position calculating unit 230 calculates the coordinates of the central position of a human face in the captured image from the face center feature map output in step S502. In step S504, the angle estimating unit 240 estimates a face direction angle based on the face direction feature maps and the central position of the face.

In step S505, the angle correcting unit 250 corrects the detection angle of the detector of the organ detecting unit 260 by the estimated face direction angle. In step S506, the organ detecting unit 260 detects the face from the captured image using the detector for which the detection angle has been corrected. In step S507, the AF processing unit 270 executes the AF processing so as to focus on the pupils of the detected face.

In step S508, the information processing apparatus 200 determines whether to continue the operations of the camera 100. It is assumed here that the operations of the camera are to be stopped in a case where the user has performed an operation of stopping the image capture by, for example, turning OFF an image capturing function of the camera 100, and the operations of the camera are to be continued otherwise. In a case where the operations of the camera are to be continued, processing returns to step S501; otherwise, processing ends.

According to the foregoing configuration, the evaluation values indicating whether a detection target in an image is inclined at the reference angles with respect to the standard orientation are output, and the inclination of the detection target with respect to the standard orientation is estimated based on the output evaluation values. Next, the detection target can be detected by way of processing in which an adjustment is made based on the estimated inclination. Therefore, the detection accuracy can be improved by way of simple processing in consideration of the inclination of the detection target in the image.

Note that in the present embodiment, the evaluation values are calculated from the elements in the vicinity of the positions in the face direction feature maps that are assumed to be the central position with reference to the face center feature map. However, no limitation is intended by this as long as the evaluation values can be calculated from the elements at the positions in the face direction feature maps that correspond to the detection target, and furthermore, the face center feature map is not indispensable. For example, the position of the face may be obtained by a different unit without using the face center feature map, and the evaluation values may be calculated from the elements of the face direction feature maps corresponding to the position of the face.

[Training Method]

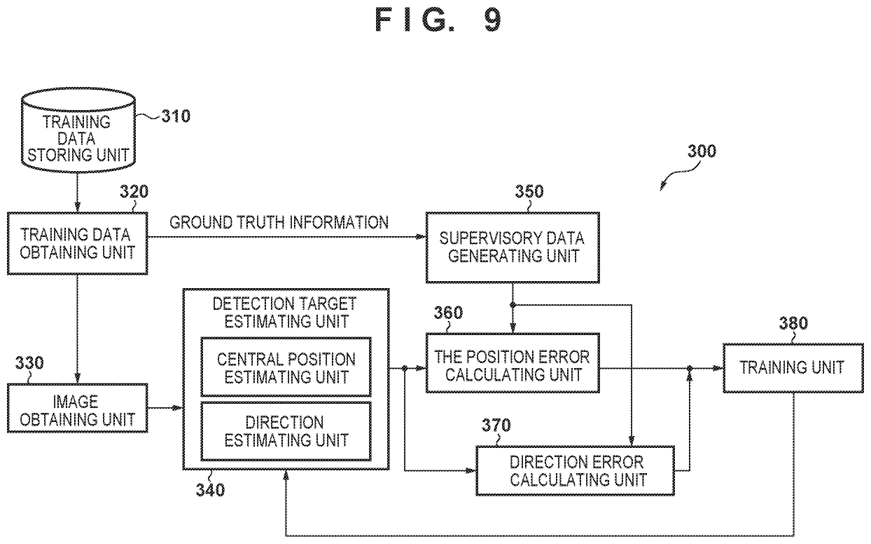

Next, a description is given of a training method in which the information processing apparatus 200 according to the present embodiment receives an image as an input and outputs the center feature map and the evaluation values of the face direction feature maps. A training apparatus 300 shown in FIG. 9 includes a training data storing unit 310, a training data obtaining unit 320, an image obtaining unit 330, a detection target estimating unit 340, a supervisory data generating unit 350, a position error calculating unit 360, a direction error calculating unit 370, and a training unit 380.

The training data storing unit 310 stores training data that is used in training performed by the training apparatus 300. Here, the training data includes a pair of an image for training and ground truth information of a human face in this image. The ground truth information includes the coordinates of the central position of the face in this image and a face direction angle thereof, and may additionally include information of the size of the face (the magnitude thereof in the image) and the like. The training data storing unit 310 may store pieces of training data that are sufficient in number for training, and may be capable of obtaining training data from an external apparatus. The training data obtaining unit 320 obtains the training data stored in the training data storing unit 310 as a processing target in training processing.

The image obtaining unit 330 obtains the image include in the training data that has been regarded as the processing target by the training data obtaining unit 320. The detection target estimating unit 340 receives, as an input, the image obtained by the image obtaining unit 330, and outputs a face center feature map and face direction feature maps by executing processing in a manner similar to the detection target estimating unit 220 of FIG. 4. The detection target estimating unit 340 is basically configured in a manner similar to the detection target estimating unit 220, and is capable of executing the same processing thereas; thus, an overlapping description is omitted.

The supervisory data generating unit 350 generates, as supervisory data that serves as a target value of training, a face center target map and face direction target maps from the ground truth information included in the training data that has been regarded as the processing target by the training data obtaining unit 320. The following describes the face center target map and the face direction target maps, together with an example of a method of generating these maps. Note, it is assumed here that the image obtained by the image obtaining unit 330 is an image with 1600×1200 pixels, which is the same as the image obtained by the image obtaining unit 210. Also note, it is hereinafter assumed that the face center target map and the face direction target maps will be referred to as “target maps” without distinction.

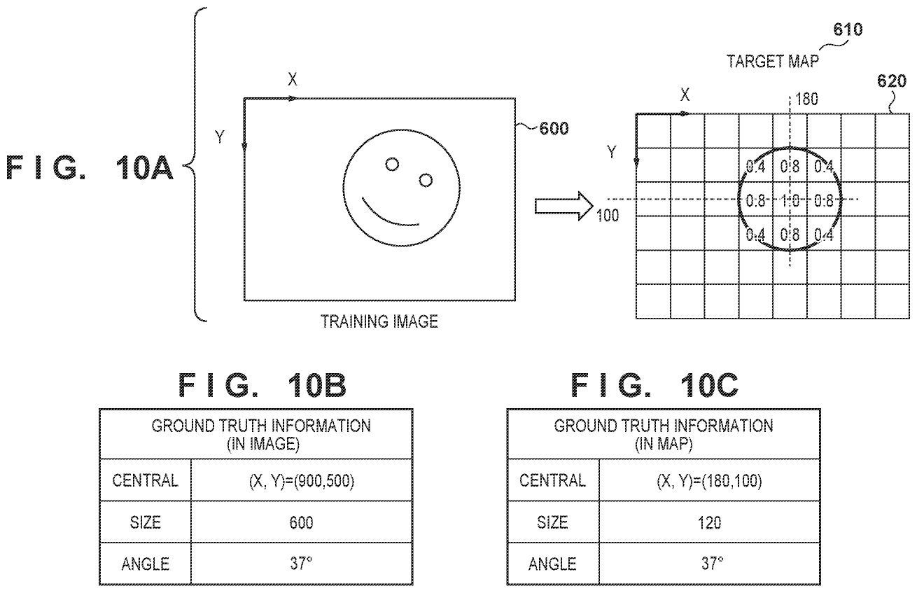

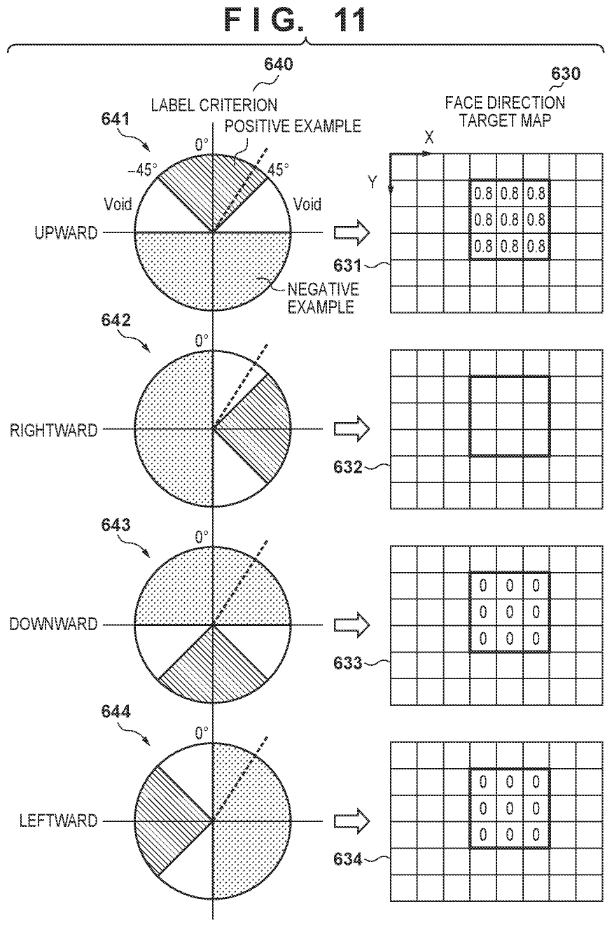

The face center target map is matrix data having the same size as the face center feature map, and includes information of the central position of a face that serves as a ground truth. In the present embodiment, the face center feature map is 320×240, and the size thereof is ⅕ of the size of the input image in each of the vertical and horizontal directions. Therefore, the coordinates of the center of the face and the size of the face in the face center target map are also ⅕ of those of the input image. The face direction target maps are matrix data having the same size as the face direction feature maps (that is to say, also having the same size as the face center target map in the present embodiment), and include information of a face direction angle that serves as a ground truth. FIGS. 10A to 10C are diagrams for describing examples of the image for training according to the present embodiment, the ground truth information of this image, and supervisory data generated from this image.

FIG. 10A is a diagram showing the image for training, FIG. 10B is a diagram showing the ground truth information thereof, and FIG. 10C is a diagram showing the ground truth information in the face center target map and the face direction target maps. According to the ground truth information of FIG. 10B, the coordinates of the central position of the face are (X, Y)=(900, 500), the size (assumed here to be the width in the X-axis direction) is 600, and the face direction angle is 37°. Furthermore, according to the ground truth information in the maps of FIG. 10C, the coordinates of the central position of the face are (X, Y)=(180, 100), the size is 120, and the face direction angle is 37°.

A face center target map 620 shown in FIG. 10A is a map in which labels of positive examples have been assigned to the central position of the face (180, 100). In the face center target map 620, a heat map that is centered at the central position of the face and corresponds to a circular region having a diameter of 120, which is the same as the size of the face, has been assigned as a label. Here, each element of the target map also has a value in the range of 0 to 1, similarly to the elements of the feature maps; the target map has been set in such a manner that the element corresponding to the central position is 1, and the value gradually decreases as the position approaches the circumference of the heat map from the central position. In FIG. 10A, the element at the central position of the target map is 1.0, the elements that neighbor this element in the up, down, left, and right directions are 0.8, and furthermore, the elements that neighbor the elements with (except for the central position) are 0.4. Note that in the present embodiment, it is assumed that the elements outside the heatmap are void (null values). In the present embodiment, void is a label that is assumed to be a null value so that it does no contribute to training.

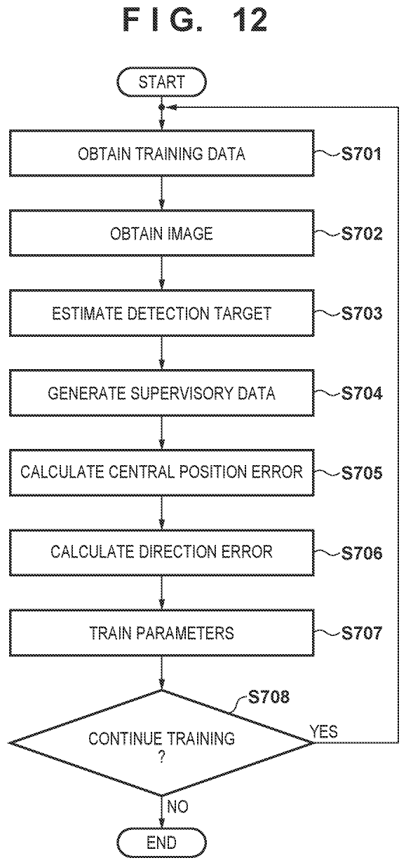

Next, the method of generating the face direction target maps will be described with reference to FIG. 11. As shown in FIG. 11, face direction target maps 630 include an upward direction target map 631, a rightward direction target map 632, a downward direction target map 633, and a leftward direction target map 634. Each of the face direction target maps 630 includes a bounding box which is centered at the central position of the face, and which has sides that are each equal in length to the value of the size of the face; inside the bounding box, a label of one of a positive example, a negative example, and void is assigned. The values set for the respective elements in each label inside a bounding box will be described later. FIG. 11 shows label criteria 641 to 644 that indicate criteria for determining which label is to be assigned to each of the face direction target maps 631 to 634.

According to the label criterion (upward direction label criterion) 641 for the upward direction target map 631, a positive example is used in the case of −45° to 45° relative to the standard orientation, void is used in the case of −90° to −45° and 45° to 90°, and a negative example is used in other cases. Although the ranges of void are not indispensable, providing the ranges of void between the range of the positive example and the range of the negative example makes it possible to prevent training from becoming unstable in the vicinity of the boundaries between the positive example and the negative example. Note that the ranges that are used here as classes are examples; a positive example can be used in a case where the absolute value |θ−θs| of the difference between the inclination angle and the reference angle is small, void can be used in a range in which the value is large compared to the case where the positive example is used, and a negative example can be used in a range in which the value is large compared to the case where void is used.

Here, as the face direction angle of the ground truth information is 37° as shown in FIG. 10C, a label of a positive example is assigned to the upward direction target map 631 with reference to the label criterion 641. The supervisory data generating unit 350 regards each element inside a bounding box of a face direction target map to which a label of a positive example has been assigned as a cosine value cos (θ−θs). In the present embodiment, θ denotes the face direction angle of the ground truth information, and θs denotes the reference angle for the corresponding face direction target map (that is to say, for the corresponding face direction feature map). The value of θs in the example of FIG. 11 is 0° for the upward direction target map 631, 90° for the rightward direction target map 632, 180° for the downward direction target map 633, and 270° for the leftward direction target map 634. Therefore, the values of the elements inside the bounding box in the upward direction target map 631 are cos 37°. It is assumed here that the value of each element is rounded to one decimal place and cos 37° is regarded as 0.8; however, no particular limitation is intended by this. Also, although the supervisory data generating unit 350 regards the elements inside a bounding box of a face direction target map to which a label of a positive example has been assigned as cos (θ−θs), other values may be used as long as they can indicate a positive example; for example, 1.0 may be uniformly used as such elements. Furthermore, the supervisory data generating unit 350 regards the elements inside a bounding box of a face direction target map to which a label of a negative example has been assigned as 0, and regards the elements inside a face direction target map to which a label of void has been assigned as null values.

The position error calculating unit 360 calculates a central position error, which is an error between the face center feature map output from the detection target estimating unit 340 and the face center target map generated by the supervisory data generating unit 350. With regard to the elements of void, the error is regarded as 0. The direction error calculating unit 370 calculates direction errors, which are errors between the face direction feature maps output from the detection target estimating unit 340 and the face direction target maps generated by the supervisory data generating unit 350. The errors related to the elements of void are similar to those in processing of the position error calculating unit 360.

The training unit 380 trains (updates) parameters of the detection target estimating unit 340 so as to reduce the central position error and the direction errors. The training processing can be executed in a manner similar to common training processing, and a detailed description thereof is omitted.

FIG. 12 is a flowchart showing an example of the training processing executed by the training apparatus 300 according to the present embodiment. In step S701, the training data obtaining unit 320 obtains training data stored in the training data storing unit 310. In step S702, the image obtaining unit 330 obtains an image for training included in the training data. In step S703, the detection target estimating unit 340 outputs a face center feature map and face direction feature maps from the image for training.

In step S704, the supervisory data generating unit 350 generates a face center target map and face direction target maps from ground truth information included in the training data. In step S705, the position error calculating unit 360 calculates a central position error, which is an error between the output face center feature map and the generated face center target map. In step S706, the direction error calculating unit 370 calculates direction errors, which are errors between the output face direction feature maps and the face direction target maps. In step S707, the training unit 380 trains parameters of the detection target estimating unit 340 so as to reduce the central position error and the direction errors.

In step S708, the training unit 380 determines whether the training is to be continued. In a case where the training is to be continued, processing returns to step S701; in a case where the training is not to be continued, processing ends. The training unit 380 may determine that the training is to be ended in a case where, for example, a predetermined number of sessions of training or training of a preset training period has been completed, and other criteria about whether the training is to be continued may be provided.

Note, although it is assumed that the detection target estimating unit 340 according to the present embodiment performs the estimation using the image obtained by the image obtaining unit 330 as an input, the image obtaining unit 330 may extend data of the image for training in this case. For example, in a case where data for training includes an insufficient amount of a human face facing a specific direction, or includes no such face, an input of such a face facing the specific direction is generated by rotating a face image; as a result, the training can be performed thoroughly, and the accuracy of estimation of the face direction can be improved. Furthermore, there are cases where improvements in robustness can be expected as a result of enlargement/reduction of the image, addition of noise, or alteration of the brightness or colors of the image. In a case where data extension that accompanies geometric conversion, such as rotation or enlargement/reduction of the image, is executed, it is necessary to convert the ground truth information of the training data as well in correspondence with such geometric conversion.

The information processing apparatus 200 according to the present embodiment estimates a face direction angle of a face that is inclined with respect to the standard orientation via in-plane rotation. However, the information processing apparatus 200 may estimate a three-dimensional inclination angle of a face with respect to the standard orientation via rotation around a pitch axis or a yaw axis in addition to in-plane rotation (rotation around a roll axis), and detect a detection target by way of processing in which an adjustment is made using the estimated inclination angle. That is to say, the information processing apparatus 200 can estimate a face direction angle in consideration of not only the angle of in-plane rotation described above, but also a rotation angle around the pitch axis or the yaw axis, as an inclination angle of a face.

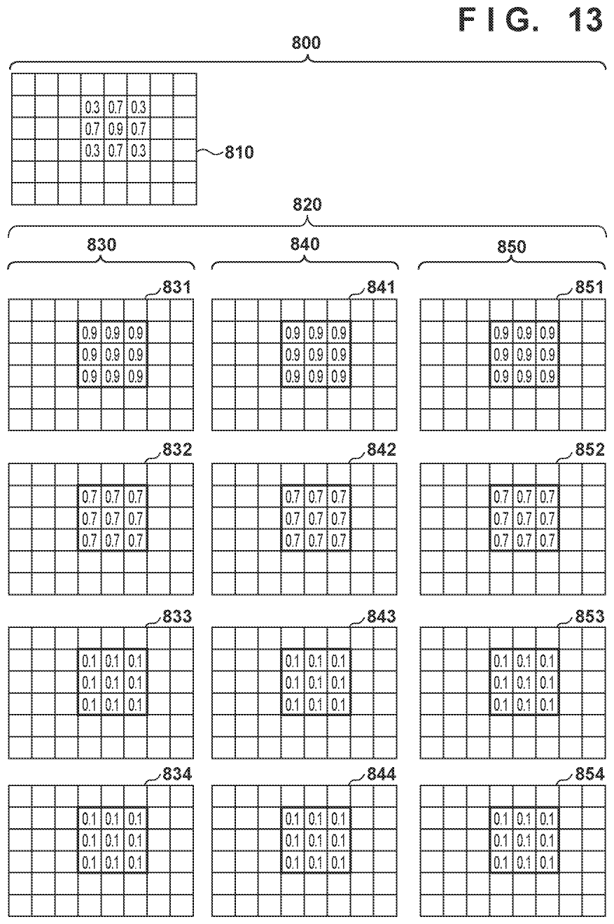

FIG. 13 is a diagram showing examples of feature maps 800 output from the information processing apparatus 200 according to the present embodiment, which include a face center feature map 810 and face direction feature maps 820. The face direction feature maps 820 include roll axis head direction maps 830, pitch axis head direction maps 840, and yaw axis head direction maps 850 as head direction maps that correspond to the roll axis, the pitch axis, and the yaw axis. Furthermore, the head direction maps 830 to 850 include maps for different directions. The face center feature map 810 is a map that is similar to the face center feature map 450 of FIG. 6.

The roll axis head direction maps 830 are maps that are similar to the face direction feature maps 460, and include maps 831 to 834 with reference angles for a face direction that respectively correspond to up, down, left, and right.

The pitch axis head direction maps 840 include a map 841 for a case where the face is facing forward, a map 842 for a case where the face is facing the zenith direction, a map 843 for a case where the face is facing backward, and a map 844 for a case where the face is facing the nadir direction. The yaw axis head direction maps 850 include a map 851 for a case where the face is facing forward, a map 852 for a case where the face is facing the right-side direction, a map 853 for a case where the face is facing backward, and a map 854 for a case where the face is facing the left-side direction. That is to say, the face direction feature maps 820 include a total of twelve maps, namely, the four maps included in the face direction feature maps 460 shown in FIG. 6, and eight additional maps.

With regard to the roll axis head direction maps 830, the information processing apparatus 200 can produce outputs through processing that is similar to processing that has been described in relation to the face direction feature maps of the first embodiment. Furthermore, with regard to the pitch axis head direction maps 840 and the yaw axis head direction maps 850 as well, the information processing apparatus 200 can produce outputs pertaining to different planar coordinate systems through processing that is similar to processing related to the roll axis head direction maps 830, and calculate the face direction angles therefrom. As described above, the information processing apparatus 200 can estimate an inclination angle of a detection target with respect to the standard orientation also in a three-dimensional coordinate system.

The training apparatus 300 can prepare target maps and perform training with respect to the head directions around each of the roll axis, the pitch axis, and the yaw axis. This processing is enabled by executing the training processing for the roll axis, which has been described with reference to FIG. 10A to FIG. 12, also with respect to the pitch axis and the yaw axis. According to the foregoing processing, a three-dimensional inclination angle of a detection target in an image can be estimated, and detection can be performed after making a correction corresponding to the estimated inclination angle.

### Second Embodiment

The information processing apparatus according to the first embodiment outputs the evaluation values, which indicate whether a detection target in an image is inclined at the reference angles with respect to the standard orientation, with use of the face center feature map and the face direction feature maps. An information processing apparatus according to the present embodiment outputs the above-described evaluation values with use of a size feature map for estimating and outputting the size of the detection target, in addition to the face center feature map and the face direction feature maps, and estimates a face direction angle using the output evaluation values.

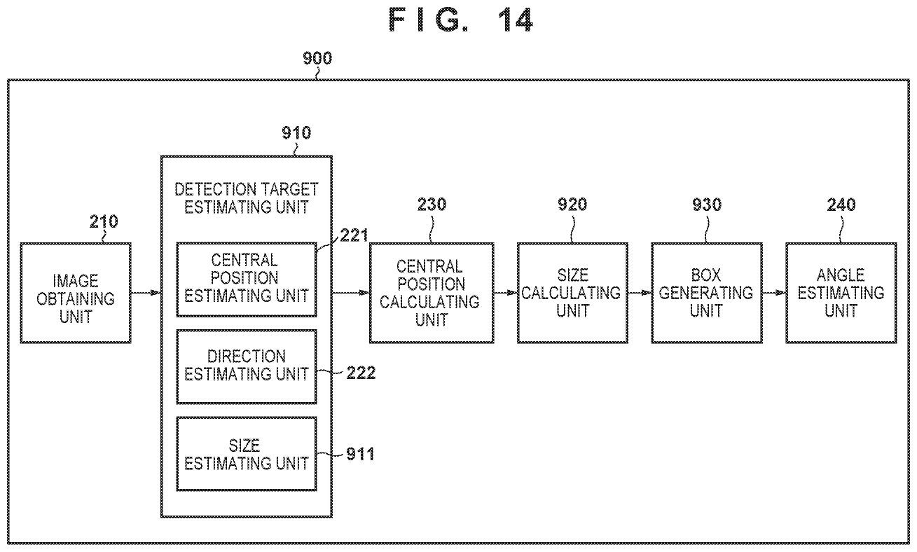

FIG. 14 is a diagram showing an example of a functional configuration of an information processing apparatus 900 according to the present embodiment. The information processing apparatus 900 is configured in a manner similar to the information processing apparatus 200 of the first embodiment, except that it includes a detection target estimating unit 910 instead of the detection target estimating unit 220, and further additionally includes a size calculating unit 920 and a box generating unit 930.

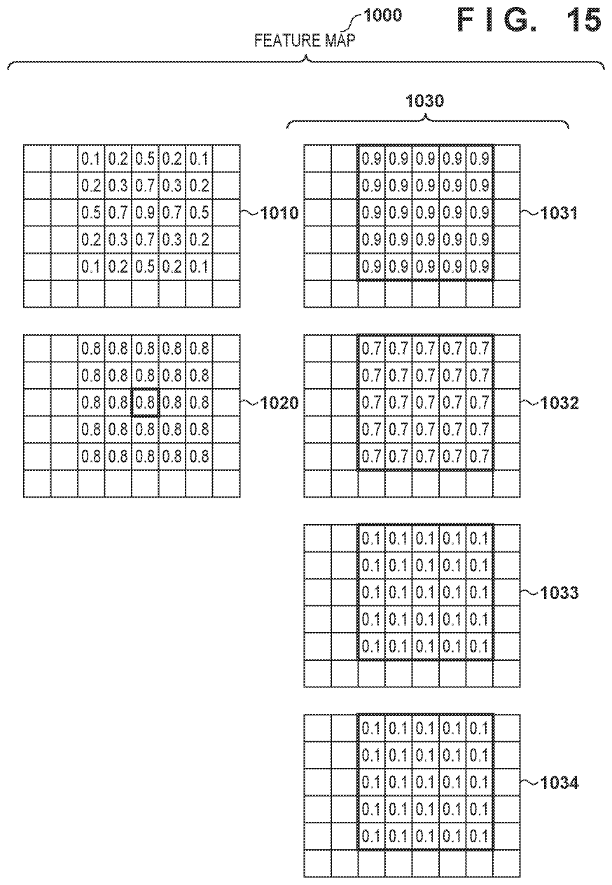

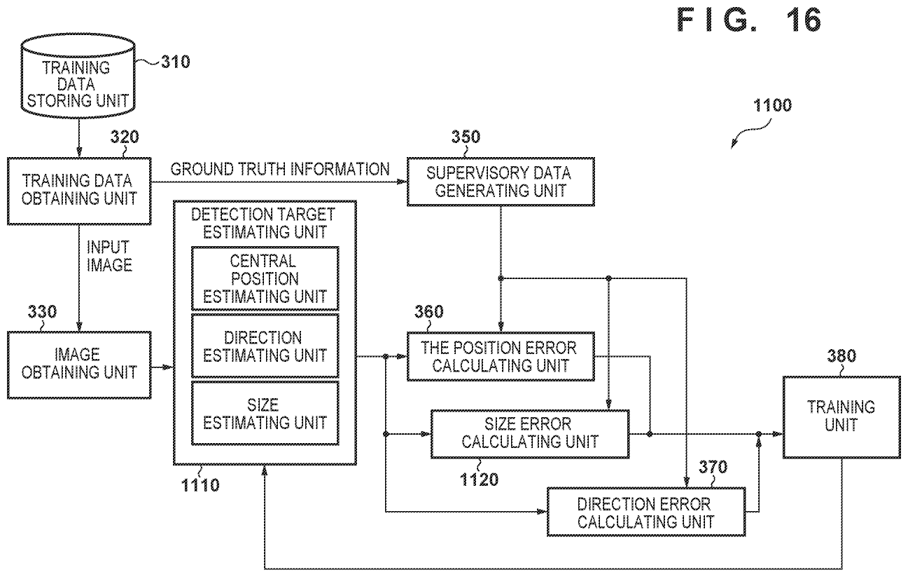

The detection target estimating unit 910 includes a size estimating unit 911, and outputs a size feature map in addition to executing the processing executed by the detection target estimating unit 220. FIG. 15 is a diagram showing examples of feature maps 1000 output from the detection target estimating unit 910 according to the present embodiment, which include a face center feature map 1010, face direction feature maps 1030, and additionally, a size feature map 1020. The face center feature map 1010 and the face direction feature maps 1030 are output through processing similar to processing for the face center feature map 450 and the face direction feature maps 460 of the first embodiment; thus, an overlapping description is omitted here. Note that the face direction feature maps 1030 include an upward direction feature map 1031, a rightward direction feature map 1032, a downward direction feature map 1033, and a leftward direction feature map 1034 as face direction feature maps that correspond to up, down, left, and right, similarly to 461 to 464 of FIG. 6.

The size feature map 1020 is two-dimensional matrix data similar to the face center feature map and the face direction feature maps, and is map that includes the value of the relative size of a face in an image as elements of a region corresponding to the face in the image, assuming that the maximum size of a face that can be recognized in the image is 1. The size estimating unit 911 has been trained so as to output the above-described size feature map while using the image as an input. Note that the present description is provided under the assumption that the width and the height of a face are the same, and the value thereof is used as a face size; however, for example, one of the width and the height of a face that are different from each other may be used as a face size, or an average value of the width and the height of a face may be used as a face size.

The size calculating unit 920 calculates a face size of a person in the image based on the size feature map 1020 and on the central position of the face output from the central position calculating unit 230. A bold, black frame shown in the size feature map 1020 of FIG. 15 indicates the central position. The size calculating unit 920 according to the present embodiment can calculate a product of the value of the central position of the size feature map and the value of the maximum face size as a face size in the image. According to the examples of FIG. 15, the value of the central position of the size feature map 1020 is 0.8; assuming that the maximum face size is 1000, 800 obtained from 1000×0.8 is calculated as the face size.

The box generating unit 930 generates a bounding box indicating a face region based on the face size output from the size calculating unit 920 and on the central position of the face output from the central position calculating unit 230. This bounding box is a bounding box which is centered at the central position of the face, and which has a width and a height represented by the value of the face size (or the value obtained by applying the value of the face size to a map).

The angle estimating unit 240 estimates a face direction angle based on the face direction feature maps 1030 and on the bounding box generated by the box generating unit 930. For each of the face direction feature maps 1031 to 1034 corresponding to four directions, the angle estimating unit 240 calculates an average value of the elements inside the bounding box as an evaluation value. In the face direction feature maps 1030 of FIG. 15, the bounding boxes are indicated by bold, black frames, and the evaluation values corresponding to up, right, down, and left are 0.9, 0.7, 0.1, and 0.1, respectively. The angle estimating unit 240 estimates the face direction angle using the evaluation values calculated in the foregoing manner; as this processing is similar to that of the first embodiment, a description thereof is omitted.

The information processing apparatus 900 according to the second embodiment can execute processing similar to processing shown in FIG. 8, except that it executes processing for outputting the size feature map, processing for calculating the face size, and processing for generating the bounding boxes between step S503 and step S504 shown in FIG. 8.

With this processing, the face direction can be estimated in consideration of a face size. Especially, as the average inside a bounding box, which indicates a face size, is used as an evaluation value, detection can be performed while exerting robustness against noise that occurs due to a change in the size of a face in the image.

Note that a bounding box generated by the box generating unit 930 according to the present embodiment is a range in which a detection target is estimated to exist in a map. Although the box generating unit 930 generates a bounding box using the face size here, such a generation method may not particularly be used as long as a range of elements corresponding to a region of a face in the image can be estimated in a face direction feature map. For example, the box generating unit 930 may generate a bounding box that surrounds a face in the image using a known detection technique, and convert the coordinates of four corners of this bounding box into corresponding positions in a map, thereby generating a bounding box to be used.

Next, a training method of a training apparatus 1100 according to the present embodiment will be described. The training apparatus 1100 according to the present embodiment is configured in a manner similar to the training apparatus 300 shown in FIG. 9 of the first embodiment, except that it includes a detection target estimating unit 1110 instead of the detection target estimating unit 340.

The detection target estimating unit 1110 receives, as an input, an image obtained by the image obtaining unit 330, and outputs a face center feature map, face direction feature maps, and a size feature map by executing processing in a manner similar to the detection target estimating unit 910 of FIG. 14. The detection target estimating unit 1110 is basically configured in a manner similar to the detection target estimating unit 910, and is capable of executing the same processing thereas; thus, an overlapping description is omitted.

Based on ground truth information, the supervisory data generating unit 350 according to the present embodiment generates not only a face center target map and face direction target maps that are similar to those of the first embodiment, but also a face size target map that serves as supervisory data for the size feature map. The following describes a method of generating the face size target map.

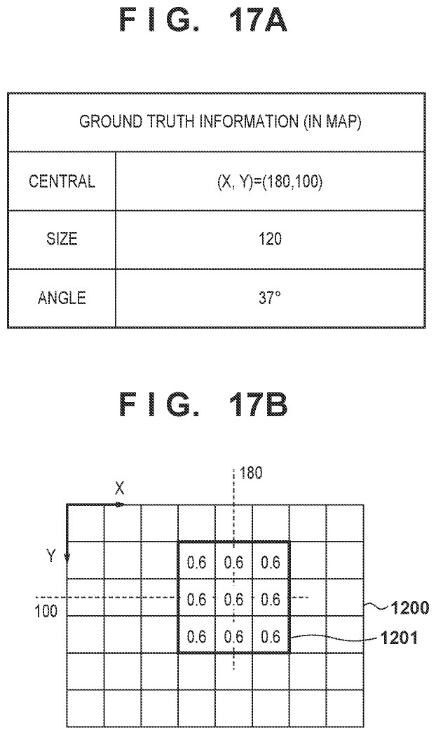

FIGS. 17A and 17B are diagrams for describing ground truth information according to the present embodiment. FIG. 17A is a diagram showing ground truth information in the maps, similarly to FIG. 10C. Here, the central position is (X, Y)=(180, 100), the face size is 120, and the face direction angle is 37°.

In a face size target map 1200 shown in FIG. 17B, a bounding box 1201 is shown which is centered at the central position (180, 100), and which has sides whose length is the same as the value of the face size. A label of a positive example has been assigned to the face size target map of FIG. 17B, and the value of each element inside the bounding box 1201 is a value obtained by dividing the value of the face size in the map by the maximum face size in the map. Here, the maximum size is 200, and thus the values inside the bounding box 1201 are 0.6 obtained from 120/200. Furthermore, the elements outside the bounding box 1201 are assumed to be void.

A size error calculating unit 1120 calculates a size error, which is an error between the size feature map output from the detection target estimating unit 1110 and the face size target map generated by the supervisory data generating unit 350. The training unit 380 trains parameters of the detection target estimating unit 1110 so as to reduce not only the central position error and the direction errors, but also the size error.

The training apparatus 1100 can execute processing similar to processing shown in FIG. 12, except that it estimates the size feature map in step S703, generates the face size target map in step S704, and executes processing for calculating the size error between step S705 and step S706.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-086229, filed May 26, 2022, which is hereby incorporated by reference herein in its entirety.

What is claimed is:

1. An information processing apparatus comprising:
an outputting unit configure to, for each of a plurality of reference angles, output an evaluation value indicating whether a detection target in an image is inclined at the reference angle with respect to a standard orientation of the detection target;
a first estimating unit configured to estimate an inclination angle of the detection target in the image with respect to the standard orientation based on the evaluation values that have been respectively output for the plurality of reference angles; and
a detecting unit configured to detect the detection target through processing in which an adjustment has been made using the estimated inclination angle.

2. The information processing apparatus according to claim 1, wherein
using an image as an input, the outputting unit outputs a matrix that includes, as an element, an evaluation value indicating whether the detection target is inclined at a reference angle with respect to the standard orientation of the detection target.

3. The information processing apparatus according to claim 2, further comprising
a second estimating unit configured to estimate a central position of the detection target in an input image,
wherein the outputting unit outputs the evaluation value from an element at a position in the matrix, the position corresponding to the estimated central position.

4. The information processing apparatus according to claim 3, wherein
the outputting unit outputs, as an evaluation value, an average value of elements in the matrix that are at a position corresponding to the estimated central position and positions within a predetermined range from the central position.

5. The information processing apparatus according to claim 2, further comprising
a third estimating unit configured to estimate a range of elements in the matrix that correspond to a region of the detection target in an input image,
wherein the outputting unit outputs the evaluation value based on the elements of the estimated range in the matrix.

6. The information processing apparatus according to claim 5, wherein
the outputting unit outputs an average value of the elements of the estimated range as the evaluation value.

7. The information processing apparatus according to claim 1, further comprising
a generating unit configured to, for each of the reference angles, generate a vector in a direction of the reference angle, the vector having a value of the evaluation value as a length,
wherein the first estimating unit estimates, as the inclination angle with respect to the standard orientation, an inclination angle of a combined vector obtained by combining the vectors that have been generated by the generating unit from the plurality of reference angles, respectively.

8. The information processing apparatus according to claim 1, wherein
the detecting unit detects a rotated detection target so as to undo the estimated inclination angle.

9. The information processing apparatus according to claim 1, wherein
the detecting unit rotates the image so as to undo the estimated inclination angle, and detects the detection target from the rotated image.

10. The information processing apparatus according to claim 1, wherein
the outputting unit outputs, for each of the plurality of reference angles, an evaluation value indicating whether the detection target is inclined at the reference angle via in-plane rotation with respect to the standard orientation of the detection target, and
based on the evaluation values, the first estimating unit estimates an inclination angle of the detection target via in-plane rotation with respect to the standard orientation.

11. The information processing apparatus according to claim 1, wherein
the outputting unit outputs, for each of the plurality of reference angles, an evaluation value indicating whether the detection target is inclined at the reference angle with respect to a standard orientation of the detection target based on three-dimensional coordinates, and
based on the evaluation values, the first estimating unit estimates an inclination angle of the detection target with respect to the standard orientation based on the three-dimensional coordinates.

12. An information processing apparatus, comprising:
an outputting unit configure to, for each of a plurality of reference angles, output an evaluation value indicating whether a detection target in an image is inclined at the reference angle with respect to a standard orientation of the detection target;
a first estimating unit configured to estimate an inclination angle of the detection target in the image with respect to the standard orientation based on the evaluation values that have been respectively output for the plurality of reference angles;
an obtaining unit configured to obtain data indicating a ground truth of the inclination angle with respect to the standard orientation; and
a generating unit configured to, with respect to each of the plurality of reference angles, generate a piece of supervisory data used in training of the evaluation value based on the data indicating the ground truth,
wherein the outputting unit has been trained so as to reduce an error between the evaluation values and the pieces of supervisory data.

13. The information processing apparatus according to claim 12, wherein
with respect to each of the reference angles, the generating unit generates one of a positive example having a positive value, a negative example having a value of 0, and a null value that is not used in the training as the piece of supervisory data based on the ground truth of the inclination angle and on the reference angle.

14. The information processing apparatus according to claim 13, wherein
with respect to each of the reference angles, the generating unit generates, as the piece of supervisory data,
a positive example in a case where an absolute value of a difference between the ground truth of the inclination angle and the reference angle is a value included in a first range,
a null value in a case where the absolute value of the difference between the ground truth of the inclination angle and the reference angle is a value included in a second range whose values are larger than values of the first range, and
a negative example in a case where the absolute value of the difference between the ground truth of the inclination angle and the reference angle is a value included in a third range whose values are larger than the values of the second range.

15. The information processing apparatus according to claim 14, wherein
the generating unit generates the positive value of the positive example as a cosine value of a difference between the inclination angle and the reference angle.

16. The information processing apparatus according to claim 14, wherein
the generating unit generates the positive value of the positive example so that the positive value is one.

17. The information processing apparatus according to claim 12, wherein
the outputting unit outputs the evaluation values using a neural network.

18. An information processing method comprising:
outputting, for each of a plurality of reference angles, an evaluation value indicating whether a detection target in an image is inclined at the reference angle with respect to a standard orientation of the detection target;
estimating an inclination angle of the detection target in the image with respect to the standard orientation based on the evaluation values that have been respectively output for the plurality of reference angles; and
detecting the detection target through processing in which an adjustment has been made using the estimated inclination angle.

19. An information processing method, comprising:
outputting, for each of a plurality of reference angles, an evaluation value indicating whether a detection target in an image is inclined at the reference angle with respect to a standard orientation of the detection target;
estimating an inclination angle of the detection target in the image with respect to the standard orientation based on the evaluation values that have been respectively output for the plurality of reference angles;
obtaining data indicating a ground truth of the inclination angle with respect to the standard orientation; and
generating, with respect to each of the plurality of reference angles, a piece of supervisory data used in training of the evaluation value based on the data indicating the ground truth,
the outputting has been trained so as to reduce an error between the evaluation values and the pieces of supervisory data.

20. A non-transitory computer-readable storage medium storing a program which, when executed by a computer comprising a processor and a memory, causes the computer to:
outputting, for each of a plurality of reference angles, an evaluation value indicating whether a detection target in an image is inclined at the reference angle with respect to a standard orientation of the detection target;
estimating an inclination angle of the detection target in the image with respect to the standard orientation based on the evaluation values that have been respectively output for the plurality of reference angles; and
detecting the detection target through processing in which an adjustment has been made using the estimated inclination angle.

21. A non-transitory computer-readable storage medium storing a program which, when executed by a computer comprising a processor and a memory, causes the computer to:
outputting, for each of a plurality of reference angles, an evaluation value indicating whether a detection target in an image is inclined at the reference angle with respect to a standard orientation of the detection target;
estimating an inclination angle of the detection target in the image with respect to the standard orientation based on the evaluation values that have been respectively output for the plurality of reference angles;
obtaining data indicating a ground truth of the inclination angle with respect to the standard orientation; and
generating, with respect to each of the plurality of reference angles, a piece of supervisory data used in training of the evaluation value based on the data indicating the ground truth,
the outputting has been trained so as to reduce an error between the evaluation values and the pieces of supervisory data.
